(19) United States
(12) Patent Application Publication
(10) Pub. No.: US 2018/0180128 A1
(43) Pub. Date: Jun. 28, 2018

(54) SHOCK ABSORBING TOOL CONNECTION

(71) Applicant: TERMINATOR IP LIMITED, Matamata (NZ)

(72) Inventor: Angus ROBSON, Matamata (NZ)

(73) Assignee: Terminator IP Limited, Matamata (NZ)

(21) Appl. No.: 15/738,203

(22) PCT Filed: Jun. 29, 2016
(86) PCT No.: PCT/NZ2016/050105

§ 371 Date: Dec. 20, 2017

(30) Foreign Application Priority Data
Jun. 29, 2015 (NZ) 709540

(51) Int. Cl. F16F 1/40; B25D 17/24; E02F 3/96; E01C 23/12

(52) U.S. Cl. CPC F16F 1/40; B25D 17/24; E02F 3/966; E01C 23/124; F16F 1/406; F16F 2230/0023; B25D 2250/085; B25D 2250/051; F16F 2224/025; F16F 2224/0208; B25D 2222/06

(57) ABSTRACT

A tool connection (9, 47) for connecting a tool (1) to a tool support (16), the tool connection (9, 47) including at least one radial shock absorber (19, 20) for at least partially absorbing shock imparted by the tool (1) via the tool connection (9, 47). The radial shock absorber (19, 20) has shock absorbing assemblies (22, 23), each including at least two elastic layers (24) and at least one inelastic layer (25) interleaved between the elastic layers (24). The layers (24, 25) of the shock absorbing assemblies (22, 23) are radially distributed with respect to a connection axis (10, 11) passing through the tool connection (9, 47), the shock absorbing elastic layers (24) including an inner elastic layer (24) and an outer elastic layer (24) radially proximal and distal respectively to the connection axis (10, 11).

### TECHNICAL FIELD

The invention relates to a shock absorbing tool connection for reducing transmission of mechanical shock from a tool to a tool support.

In particular, the invention relates to a tool connection with a shock absorber for reducing transmission of shock from an impact hammer to a carrier such as an excavator.

Reference throughout the specification is made to the invention as relating to shock absorption of shock from breaking tools in the form of impact hammers although this should not be seen as limiting.

### BACKGROUND ART

Gravity drop hammers are primarily designed for surface breaking of exposed rock and generally consist of a weight capable of being raised to a height within a housing before release. The weight falls under gravity to strike a surface to be broken, either directly (thus protruding through an aperture in the hammer housing) or indirectly via a striker pin.

The present invention is discussed herein with respect to rock breaking devices invented by Robson including the devices described in U.S. Pat. Nos. 7,407,017, 7,331,405 and 4,383,363 (all incorporated herein by reference) featuring a drop hammer lock, drive mechanism and rock breaking apparatus respectively. The term gravity drop hammer is thus used herein to encompass powered drop hammers in addition to those powered solely by gravity.

Elevated stress levels are generated throughout the entire hammer apparatus and associated supporting machinery (e.g. an excavator, known as the carrier) by the high impact forces associated with such breaking actions. U.S. Pat. No. 5,363,835 (incorporated herein by reference) by Robson discloses an apparatus for mitigating the impact forces from such operations by using a unitary shock absorbing means in conjunction with a retainer supporting a striker pin within the nose piece of the hammer.

The unitary shock absorbing means is a block of at least partially elastic material which compresses under the impact force of the moveable mass on the striker pin. The striker pin attachment to the nose piece is configured with a small degree of allowable travel constrained by a pair of retaining pins fitted to the retainer and allowing movement along the longitudinal striker pin axis via recesses formed into the sides of the striker pin.

Despite the advantages of the system described in U.S. Pat. No. 5,363,835, there was an ongoing desire to further attenuate the effects of impact forces on the device and/or reducing the device weight, to allow the use of a smaller carrier. Thus, an improved hammer shock absorption system was invented by Robson and is described in U.S. Pat. No. 8,181,716 (incorporated herein by reference).

In operation of the above-mentioned machines it is often desirable to move or lever rock and other material with the hammer or striker pin. Movement of the material can be achieved by placing the hammer or pin against the material and pushing or pulling with the carrier. However, with many hammers the coupling between the hammer and carrier, known as the mounting plate, is a substantial distance from the striker pin so the pulling forces at the striker pin are low and difficult to control. This large separation between the striker pin and the mounting plate coupling with the carrier also increases the likelihood of generating high uncontrolled forces that can damage the hammer. Mounting the hammer at a distance from the striker pin thus causes time consuming, inaccurate and inconvenient operation of the hammer for the operator.

Raking refers to using the carrier to pull surface rock horizontally along the ground using the side of the pin. The rock can be loose above the ground surface or be friable enough to be drawn towards the carrier after pressing or driving the point of the pin into the in-situ rock. When raking it is necessary for the hammer and arm assemblies to remain locked relative to each other. The linkage geometry to maintain such a locked position requires far greater strength than conventional mounting methods, though ideally the linkage should still utilise standard components.

Levering is a particularly useful action of the rock breaking apparatus afore-mentioned. Levering refers to the driving of the point of the striker pin or hammer into non-friable in-situ rock creating or exploiting a crack. Once the crack is established, the operator can lever the hammer and pin through actuation of one end of the boom attached to the carrier and extract the rock from the ground or widen the cracks further. In such applications it is an important advantage to have the maximum torque and thus leverage available to pry intractable rocks.

Another advantage of being able to lever a powered hammer or breaking device is being able to apply the impact point at positions away from the top surfaces of the material to be broken. This is an important advantage of the devices described in U.S. Pat. Nos. 8,316,960, 7,407,017 and 7,331,405 (all incorporated herein by reference). The rock often requires fine manipulation to correctly position the hammer impact over a seam or weak point. In such scenarios, delivering high power in combination with fine control close to the striker pin provides a significant advantage.

The theoretical maximum lifting capacity of a carrier is the moment resolved about the ends or sides of the tracks without tipping the carrier. The allowable lifting moment is a percentage of the tipping moment. However, not all this moment is available for lifting. The carrier arm and hammer assembly extending from the carrier apply a moment to the carrier which must be subtracted from the maximum lifting moment and is governed by;
a. the distance between the carrier and the drop hammer,
b. the mass of the carrier arm and drop hammer, and
c. any forces applied to the drop hammer or carrier arm.

Thus by minimising the counterproductive inherent tipping moment created by a)-b) above, the capacity of the carrier to resist any additional moments generated during levering and raking operations without tipping over is increased.

The impact energy of the drop hammer, divided by the mass of the carrier is herein defined as the power-to-weight ratio. A greater power-to-weight ratio implies either more breaking power for a given carrier size or a smaller carrier for a given breaking power. The profitability of a system is thus increased by a higher power-to-weight ratio.

Existing gravity drop hammers are attached to carriers via a wing and mounting plate arrangement attached to the carrier arm. These mounting plates must be custom made for each drop hammer and carrier to ensure the geometrical proportions of the plate are correct. The mounting plate and associated fixings on the drop hammer also add substantial weight to the drop hammer, thereby reducing the power-to-weight ratio and absorbing more moment capacity of any given carrier. The wing and mounting plate also increase the distance from the carrier to the centre of gravity of the drop hammer, which also reduces the power-to-weight ratio and absorbs more lifting moment capacity for a given carrier and arm extension.

In many regions globally, restrictions on excavation, demolition and quarry operations prevent the use of explosives due to the elevated risks of explosives theft by unauthorized parties including rebels, terrorists and the like. Urban encroachment on quarries and mines has also made the use of explosives difficult and expensive in many regions due to community opposition to ground vibration. Obtaining the necessary permissions or consents from the relevant authorities to use explosives for laying roads, railways and pipelines has also become extremely difficult or impossible to achieve due to the above discussed factors. In such regions, it is thus desirable for a rock breaking machine to also be capable of levering embedded rocks, widening cracks, breaking rock faces and raking without the use of explosives.

The aforementioned problems have been addressed by Angus Robson through the invention of the articulated control linkage described in U.S. Pat. No. 8,037,946, incorporated herein by reference. The articulated control linkage of U.S. Pat. No. 8,037,946 is used to connect the impact hammer to a carrier such as an excavator and provides:
a. An enhanced levering and raking ability, achieved by maximising both the range of rotation and torque about the main pivot.
b. An implement readily attachable to typical carrier arms such as those designed for bucket attachments.
c. An efficient installation process, achieved by providing one or more links of adjustable length.
d. A high power-to-weight ratio and lifting capacity, achieved by minimising the weight of the implement—carrier arm attachment mechanism.

However, it has been found that the forces applied through:
I. raking,
II. levering, and/or
III. reaction force resulting from impacts on surfaces non-perpendicular to the impact axis,
   can damage the hammer or mounting to the carrier and cause significant discomfort to the operator in the carrier cab.

The carrier and carrier arm holds the hammer rigidly in position. Therefore, shock and loads on the hammer that are not aligned with the impact axis can create significant stresses on the connections between the hammer and carrier (e.g. via the linkage and primary hammer mounting) as the hammer tries to move relative to the carrier arm.

The forces imparted by the aforementioned impact hammers can be extreme, sufficient to break cast steel blocks and potentially exceeding 85 tonnes. The shock force can thus cause significant damage to the hammer and any connections to the carrier, cracking the steel in the connections or carrier arm. Although the strength of the machinery can be increased it is with added weight and cost.

The most damaging reaction forces are those that are lateral or torsional to the impact axis of the hammer as the forces along the impact axis are sufficiently dissipated by the hammer and its own shock absorption systems. Lateral or torsional forces may result from levering, raking or strikes on surfaces non-perpendicular to the strike axis.

It would thus be desirable to provide shock absorption between the hammer and carrier.

In most prior art breaking applications the carrier's weight is used to force the tool against the surface to be broken. Shock absorbers isolating the tool from the carrier arm are thus considered undesirable in such applications as the shock absorbers will deform under the carrier's weight and thus have little or no further deformation available to absorb shock, rendering them non-functional. Thus, in those applications where the carrier's weight is used on the tool, shock absorption systems are used for isolating the carrier cab from the carrier arm tool. An exemplary shock absorber is described in U.S. Pat. No. 2,426,587 and has a spring to dampen the force imparted to the carrier cab from the boom.

However, in the gravity drop hammer applications described above, the falling weight applies the downward force to the work surface via the striker pin. The gravity drop hammer thus obviates the need to use the carrier to apply downward force to the hammer, other than use in positioning the tool or for levering and raking.

In the aforementioned raking and levering applications it is necessary to pivotally attach the hammer to the carrier arm, requiring a shock absorber capable of absorbing shock at the pivot connection. This shock has been addressed in the past by providing radial shock absorbers or linear shock absorbers attached to the pivot.

Numerous radial shock absorbers exist in various shapes and forms which could be used for such applications. An exemplary radial shock absorption system for use in carrier tool applications is described by Jo et al. in PCT Publication No. WO2013/109085 and includes both linear shock absorber pads and radial shock absorbers, the radial shock absorbers are provided in the form of rubber bushings for dampening the vibration from the vibratory ripping tool.

The tool-arm connection bushings in the Jo et al. device include a rubber bushing bonded to inner and outer steel rings. Such an arrangement may be suitable for the relatively low magnitude/high frequency forces imparted by the vibratory ripper but would be damaged in the relatively low frequency/high-magnitude forces such as in the impact hammers described above.

Solid elastomers act as essentially incompressible solids, deforming while retaining the same volume. The elastomers must therefore have space in which to deform to function as shock absorbers. Therefore, the shape factor should be optimized to achieve the expected stiffness. The Jo et al. bushings are not large enough to deform sufficiently under high loads and are thus not suitable for the gravity drop hammer applications described above.

The shock absorbers of the Jo et al. device would need to be enlarged by an order of magnitude, over 10× (for a given hammer weight/carrier size) to provide sufficient shock-absorption when used with the hammers described above. However, enlarging the shock absorbers would result in larger and heavier equipment. Moreover, the low shape factor material used in the shock absorbers would permit significant movements in the hammer when under shock making precision operation and accurate repeated strikes difficult.

The impact hammers as aforementioned apply very high mechanical shocks to the machinery and thus there is a high potential for the steel in the connections, mountings or carrier arms to crack. Using conventional prior art shock absorbers to mitigate the shock inherently results in larger and heavier connections and is undesirable for the impact hammer applications described above where weight must be minimised and space constraints prevent utilisation of larger shock absorbers.

It would thus be desirable to provide a shock absorber, tool connection and/or system that has at least one of the following advantages:
a. reduces the force transmitted to the tool support (e.g. carrier arm) from the tool;
b. reduces the loadings on the connection(s) to the carrier;
c. is sufficiently robust to withstand very high shock loads;
d. is economical to produce and replace after wear;
e. can be replaced quickly without requiring offsite disassembly;
f. reduces torsional and/or lateral shock to the tool support:
g. relatively small, so that large, heavy and costly housings and retaining means are avoided.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process. Further aspects and advantages of the present invention will become apparent from the ensuing description which is given by way of example only.

### DISCLOSURE OF INVENTION

Throughout the specification, reference is made to a “tool” being a hammer attached to a corresponding “tool support” provided in the form of an arm of a carrier such as an excavator. However, this should not be seen to be limiting as the “tool” may include any working implement and any attachments or mountings thereto, whilst the “tool support” may include any carrier or mounting as well as any associated tool support components, for example, intermediate members or couplings, linkages between tool and tool support, drives between tool and tool support and/or linkage or any other component.

The terms “absorb” and “absorbing” with reference to shock, vibration or the like refer to an at least partial conversion of kinetic energy to another form of energy, typically heat, elastic potential energy, and/or sound.

The term “shock” as used herein should be understood to refer to mechanical shock.

Reference herein to the term “shock absorber” should be understood to encompass an isolation mount, vibration dampener, vibration isolator, shock mount, bushing, and any analogous or similar devices.

As used herein, the terms “radial” and “radially” should be understood to relate to a direction radiating perpendicular to an axis or a point and need not relate to circles or cylinders.

As used herein, the term “shaft” should be understood to refer to any axle, pin, pivot, fulcrum, stub, joint, ball or other component about which another component may rotate or pivot.

As used herein, the terms “pivot′, pivotal, pivotally” should be understood to include any degree of relative rotation between two components, e.g. between a tool and tool support, and does not necessarily require a 360 degree range of rotation.

Reference herein to a “connection” should be understood to refer to any joint, coupling, interface, attachment or any other connection between components.

The term “layer” as used herein is defined as a thickness of material covering a surface and includes any layer composed of distinct sub-layers of the same material or distinct sub-layers of differing material having similar properties. A “layer” need not be planar nor be a continuous thickness over the covered surface.

According to a first aspect of the present invention there is provided a tool connection for connecting a tool to a tool support, the tool connection including at least one radial shock absorber for at least partially absorbing shock imparted by the tool via the tool connection, the radial shock absorber having at least one shock absorbing assembly including:
at least two elastic layers;
at least one inelastic layer located between said elastic layers,
   wherein the layers of the shock absorbing assembly are radially distributed with respect to a connection axis passing through the tool connection, the shock absorbing assembly elastic layers including an inner elastic layer and an outer elastic layer radially proximal and distal respectively to the connection axis.

Preferably, the tool is pivotally connected to the tool support, the connection axis being a pivot axis about which relative rotation of the tool and tool support can occur.

It will be appreciated that the connection axis may pass through any part of the tool connection and at any orientation as long as the shock absorbing assembly layers are radially distributed with respect to the connection axis.

A radial shock absorber as described herein should be understood to refer to a shock absorber capable of at least partially absorbing shock in at least two non-coaxial directions perpendicular to the connection axis.

Alternatively, the tool may not be pivotally connected to the tool support, the tool connection providing a non-rotatable connection therebetween. The tool connection may for example include a square shaft rigidly mounted to the tool and coupled at either end to square sockets in the tool support, thereby preventing rotation. Alternatively, a pivotal tool connection may be utilised with the tool and tool support constrained together to prevent relative rotation.

The tool connection may include an excavator quick coupling or other coupling mechanism rigidly mounting the tool to the tool support about one or more connection axes.

According to one aspect of the present invention there is provided a radial shock absorber for absorbing shock imparted by a tool, the shock absorber having at least one shock absorbing assembly including:
at least two elastic layers;
at least one inelastic layer located between said elastic layers.

Preferably, the at least one shock absorbing assembly is radially distributed between an inner inelastic layer and an outer inelastic layer. The inner elastic layer of the shock absorbing assembly thus located adjacent the inner inelastic layer and the outer elastic layer of the shock absorbing assembly located adjacent the outer inelastic layer. The inner and outer inelastic layers provide radial constraints for the shock absorbing assembly.

Preferably, the outer inelastic layer includes the inner walls of a housing at least partially encircling the connection axis.

According to another aspect of the present invention there is provided a shock absorber for absorbing shock imparted by a tool, the shock absorber located at a tool connection between the tool and a tool support, the shock absorber having at least two shock absorbing assemblies, each assembly located between two inelastic layers of the tool connection, each shock absorbing assembly including
at least two elastic layers;
at least one inelastic layer located between the two elastic layers.

Preferably, said tool support includes one or more tool support components including the tool support itself and at least one of:
an intermediate member;
a linkage between tool and tool support;
a drive between tool and tool support;
a drive between tool and linkage.

Preferably, a said tool connection includes a shaft with a longitudinal axis forming said connection axis.

The connecting components (e.g. the tool or tool support) of the tool connection may both rotate with respect to a said shaft. In alternative embodiments:
the shaft may be fixed to one of the components, e.g. the tool or tool support with the other rotating with respect to the shaft, or
the shaft may be fixed or otherwise non-rotatably attached to both components such that the tool connection does not pivotally connect the tool to the tool support.

The shaft may preferably form the inner inelastic layer of the tool connection.

Preferably, the shock absorbing assembly layers are radially distributed between the shaft and the outer inelastic layer. Thus, the shock absorber may be capable of absorbing shock passing from the tool via the shaft.

Preferably, the tool is an impact hammer and the tool support is an operating arm of a carrier, e.g. an excavator.

Preferably, the tool is a hammer formed with a moveable mass in a hammer housing and a ‘striker pin’. During breaking operations, the tip of the striker pin projecting from the hammer housing is placed in contact with the target surface and the mass is propelled (again either by gravity or under assistance) to strike the opposing end of the striker pin which transfers the impact via the external striker pin tip to the target surface.

The hammer may alternatively be formed as a unitary mass with an impact head and may be gravity driven or assisted by a drive down mechanism such as that described in U.S. Pat. No. 7,331,405.

According to another aspect of the present invention there is provided an impact hammer including:
a movable mass capable of linear reciprocating movement for impact along an impact axis,
an elongated striker pin received within the hammer having a longitudinal axis substantially parallel or coaxial with said impact axis, said striker pin having two opposed ends with one end projecting from the hammer to form an operative tool head;
a tool connection, hereinafter “primary tool connection”, adapted for attaching the hammer to a distal end of an operating arm attached to the carrier;
   characterised in that the impact hammer includes at least one shock absorber at the primary tool connection.

According to another aspect of the present invention there is provided an impact hammer including:
a movable mass capable of linear reciprocating movement for impact along an impact axis,
an elongated striker pin received within the hammer having a longitudinal axis substantially parallel or coaxial with said impact axis, said striker pin having two opposed ends with one end projecting from the hammer to form an operative tool head;
a tool connection, hereinafter “primary tool connection”, adapted for attaching the hammer to a distal end of an operating arm attached to the carrier for pivotal movement of the hammer about a primary axis orthogonal to said impact axis;
an articulated control linkage including first and second links for effecting said pivotal movement of the hammer about said primary axis in response to movement from a drive attached to said operating arm,
   said first link being pivotally attachable:
      to said hammer at a first end to form a secondary pivot axis parallel to said primary axis,
      at a second end to said drive forming a tertiary pivot point axis and
      to said second link,
   said second link being pivotally attachable
      at a first end to the operating arm forming a quaternary pivot axis parallel to said secondary and tertiary axes,
      at a second end to said second end of said first link and
      at a second end to said drive,
         characterised in that at least one of the: articulated linkage; hammer; drive; and/or operating arm, includes a tool connection with at least one shock absorber for absorbing shock transmitted from the hammer.

The hammer shock absorbers at the primary tool connection may include a shock absorber as described herein or alternatively may include other radial shock absorbers such as elastic bushings or the like.

Preferably, a said shock absorber is located at one or more tool connections formed between:
said hammer and said operating arm, at the primary pivot point;
said first link and said hammer;
said first link and said drive;
said first link and said second link;
said second link and said operating arm;
said second link and said drive.

Preferably, at least two said shock absorbers are provided,
a first shock absorber located at the primary pivot point at a tool connection formed between said hammer and said operating arm, and
at least one further shock absorber located at one or more tool connections formed between:
   said first link and said hammer;
   said first link and said drive;
   said first link and said second link;
   said second link and said operating arm;
   said second link and said drive.

Preferably said first link includes a pair of arms spaced apart to receive the hammer therebetween. The use of two (preferably symmetrically configured) arms increases the strength and structural integrity of the first link. Although the use of a single arm may be implemented, such a configuration places limitations on the torque that may be applied during levering actions without twisting and bending the single arm about the arm's longitudinal axis. In alternative embodiments said first link may include a pair of jaws or other encircling members pivotally coupled to the hammer. Configuring the hammer attachment to the carrier arm to allow the hammer to effectively pass ‘through’ the attachment, rather than attaching to the side or end of the hammer, provides significant control and strength advantages.

It can be seen that in an alternative embodiment, said quaternary pivot axis may be coaxial with said primary pivot axis. However, typical excavator arms are configured with the primary pivot point at a distal end of the arm with the quaternary pivot point and second link located at an intermediate position between the primary pivot point and the drive.

The hammer shock absorbers at the hammer tool connections described above may include a shock absorber as described herein or alternatively may include other radial shock absorbers such as elastic bushings or the like.

As used herein, an elastic layer may be formed from any material with a Young's Modulus of less than 1 GigaPascals (GPa), while an inelastic layer is defined as including any material with a Young's Modulus of greater than 1 GPa. (and preferably greater than 10 GPa). It will be appreciated that such a definition provides a quantifiable boundary to classify materials as elastic or inelastic, though it is not meant to indicate that the optimum Young's Modulus necessarily lies close to these values. Preferably, the Young's modulus of the inelastic and elastic layer is >10×10⁹ N/m² and <0.5×10⁹ Nm⁻² respectively.

The inelastic layer may be constructed from any of various materials or may be a composite of multiple different materials. The inelastic material may include a Nylon, typically having a Young's modulus of 2-4 GPa. However, preferably, the inelastic material is a much harder material such as steel (typically with a Young's modulus of 200 GPa) or similar material capable of withstanding the high stresses and compressive loads. The elastic material may be selected from a variety of such materials exhibiting a degree of resilience, though polyurethane (with a Young's modulus of approximately 0.15×10⁹ Nm⁻²) has been found to provide ideal properties for this application.

During compressive loads, natural rubber materials and the like may reduce in volume and/or display poor heat, resilience, load and/or recovery characteristics. However, an elastomer such as polyurethane is essentially an incompressible fluid and thus tries to alter shape (not volume) during compressive loads, whilst also displaying desirable heat, resilience, load and recovery characteristics. Thus, by forming the elastomer into an ‘elastic’ layer constrained on opposing substantially parallel planar sides by rigid/non-elastic ‘inelastic’ layers, a compressive force applied substantially orthogonal to the plane of the constrained layers causes the elastomer to expand laterally. The degree of lateral deflection depends on the empirically derived ‘shape factor’ given by the ratio of the area of one loaded surface to the total area of unloaded surfaces free to expand.

Using elastomer layers between parallel inelastic layers causes the elastomer surfaces in contact with the plates to spread laterally, effectively increasing the effective load bearing area. It has been determined that a shock-absorbing assembly of multiple steel plates, interleaved between layers of polyurethane provides an effective configuration to allow each polyurethane layer to expand laterally under compressive load by approximately 30% without detrimental effect, whilst providing far greater compressive strength than could be achieved with a single unitary piece of elastic material.

Moreover, significant levels of friction occur between the elastic and inelastic layers as the elastic layer deflects. The friction opposes the elastic layer deflection and thus dramatically improves the shock-absorption capacity relative to a bonded multi-layer or unitary shock absorber. Thus, in contrast to conventional shock absorbers which rely solely on deformation of a single layer to absorb shock, the multi-layered shock absorber described herein utilises the friction resulting from relative movement of adjacent layers acts to convert a greater portion of the kinetic energy of the shock.

The increased shock absorption capabilities of a multi-layered shock absorber allow a reduced volume shock absorber to be used with an equivalent shock-absorption capacity to that of a single thicker layer with higher volume while only subjecting the individual elastic layers to a manageable degree of deflection. As an example, two separate layers of polyurethane of 30 mm, deflecting 30% (i.e. 18 mm) possess twice the load bearing capacity of a 60 mm layer deflecting 18 mm.

It should be appreciated that the shock absorbing assembly layers need not be of a constant thickness and may be sized and shaped in any way to suit the application.

Preferably, the inelastic and elastic layers are un-bonded, permitting relative movement therebetween. As mentioned above, relative movement between the layers creates friction which acts to oppose deflection of the elastic layer and thus the shock force transmitted to the tool support from the tool.

Preferably, the shock absorbing assembly includes multiple inelastic layers interleaved between corresponding pairs of elastic layers. A stacked or radially distributed shock absorbing assembly is thus produced, increasing the shock absorption capacity by increasing:
a. number of elastic layers, and
b. the total contact surface area between elastic and inelastic layers and thus total friction opposing deflection.

The hammer applications as aforementioned utilise a tool in the form of an impact hammer pivotally attached via one or more tool connections to a tool support in the form of an excavator or other carrier. The shock load in these applications is transmitted radially from the connection axis of the tool connection to the tool support and/or as a result of a twisting moment about an axis perpendicular to the connection axis.

The prior art has addressed shock absorption in radial shock applications by utilising bearings, bushings or the like encircling the connection axis, thus radial shock in any direction is absorbed. However, as described above, such shock absorbers need to be large in order to effectively mitigate high shock loads as they rely solely on deformation to absorb shock. Thus, the prior art radial shock absorbers are not optimal for high-shock applications where minimising space and weight is important.

In contrast to the prior art, preferred embodiments of the shock absorbers described herein utilise interleaved un-bonded elastic and inelastic layers. The friction caused by relative movement between the layers provides a much higher shock absorption capacity for an equivalent volume prior art absorber, thereby enabling a much smaller shock absorber to be used.

Preferably, the shock absorber includes at least a first and a second said shock absorbing assemblies located at a tool connection between any two of a tool, tool support and/or linkage therebetween, the shock absorbing assemblies arranged about a longitudinal axis (hereinafter “connection axis”) of a shaft in the tool connection, the shaft acting as the pivot between any two of said tool, tool support and/or linkage therebetween.

Preferably, the layers of the shock absorbing assemblies are radially distributed or stacked with respect to the connection axis, with an inner layer radially closer to the connection axis than an outer layer. The inner layer is thus proximal to the connection axis.

Preferably, each shock absorbing assembly only partially encircles the connection axis, in contrast to the prior art which fully encircle the connection axis.

Preferably, multiple shock absorbing assemblies collectively only partially encircle the connection axis.

Preferably, the shock absorber includes at least one deformation void for the elastic layers to deflect or deform into. A said deformation void may preferably be formed in a gap about the connection axis between adjacent shock absorbing assemblies. In one embodiment a deformation void may be provided between inelastic layers adjacent a periphery of a said elastic layer.

The deformation voids may alternatively be formed in the elastic and/or inelastic layers as recesses, troughs, depressions, apertures or any other shape or surface contour providing a void for the elastic material to deflect or deform into.

Some applications may have asymmetric loading on the shock absorber, with one assembly bearing more of the load than the other. Thus, it should be noted that the two assemblies need not have the same number of layers.

Preferably, the shock absorbing assemblies diametrically oppose each other about said connection axis. Where three or more shock absorbing assemblies are included, the shock absorbing assemblies are preferably evenly distributed about the connection axis though may be arranged in any manner depending on the direction and magnitude of principal load.

In contrast to a bearing, bushing or other fully encircling shock absorber, alignment of the shock absorbing assembly layers is important to ensure the direction of principal load intersects the elastic layers. If for example an elastic layer moves to a different angular position about the connection axis it may not overlap or be coterminous with the subsequent inelastic layer, thus reducing the contact surface area between layers and thereby the shock absorption capability of the assembly.

Preferably, the elastic layers are substantially coterminous perpendicular to the direction of principal load and preferably are substantially coterminous with at least a portion of adjacent inelastic layers.

Preferably, the at least one shock absorbing assembly includes at least three elastic layers and at least two inelastic layers, the inelastic layers interleaved between adjacent pairs of elastic layers.

Alignment is preferably maintained by:
a locator, positioned between the connection axis and said shock absorbing assemblies,
location features of the shock absorbing assembly layers,
nesting of layers, and/or
an interior surface of the housing about the connection axis.

The layers may be shaped to nest together to maintain alignment, for example, the layers may be shaped as truncated pyramids or truncated cones, nested together.

The locator preferably takes the form of a shaped locator bearing located at the tool connection about the connection axis and limiting movement of the shock absorbing assemblies about the connection axis, relative to the locator.

The locator may take any shape capable of limiting movement of the shock absorbing assemblies about the connection axis, relative to the locator. In one embodiment for example, in cross-section perpendicular to the connection axis, the locator is a polygon or truncated ellipse. In another embodiment the locator has a hexagonal cross-section.

In another embodiment the locator has an irregular hexagonal cross-section with a long axis and short axis intersecting at the connection axis.

Preferably, the locator includes a locator bearing, with an aperture for a shaft to pass therethrough which is capable of rotating about the connection axis relative to the locator bearing.

At least the inner layer of the shock absorbing assembly layer is preferably shaped to correspond to the surface of the locator radially outermost with respect to the connection axis. Preferably, all layers of the shock absorbing assembly layer are preferably shaped to correspond to the surface of the locator radially outermost with respect to the connection axis.

Preferably, the shock absorber includes a said locator and two shock absorbing assemblies with inner layers abutting radially outer faces of the locator.

Preferably, the locator is constructed of an inelastic material.

Preferably, at least one said inner layer is an elastic layer.

Preferably, an outer layer of each said shock absorbing assembly is an elastic layer.

Preferably, location features are provided in or on the shock absorbing assembly layers to limit relative movement of adjacent layers.

Preferably, the location features are provided as mating, interlocking or meshing features on adjacent layers.

In one embodiment the location features may take the form of one or more projections formed on one or more of the layers mating with corresponding recesses or apertures on a corresponding adjacent layer(s). The projections, apertures and/or recesses may be of any suitable shape and by way of example the projections may include ridges, domes, spikes, teeth.

In one embodiment the location features may take the form of shaped surface features biasing at least parts of adjacent layers together.

Preferably, the projections are provided on at least one said inelastic layer for insertion into a corresponding aperture or recess in an adjacent elastic layer(s).

It is important that elastic layers interleaved between inelastic layers are capable of deforming under compression of the assembly, i.e. when the inelastic layers move towards each other. Therefore, preferably the projections extend partially through the thickness of the elastic layers, i.e. they do not extend completely through the elastic layer to contact a further opposite inelastic layer.

The location features may however cause damage to the elastic layers if there is sufficient relative movement between layers such that, for example, a projection pushes against the side of a corresponding aperture. The portions of the elastic layers toward their periphery generally move a greater distance under compression than portions closer to the center and therefore have the potential to provide the greatest degree of relative movement between layers. Thus, it is preferable to locate the location features on portions of the layers that experience the least or only small degrees of relative movement with adjacent layers.

Thus, in one embodiment, a said location feature is located proximal to the center of the corresponding layer.

Preferably, a said shock absorber is contained within tool support coupling and/or linkage coupling, the couplings forming housings with interior surfaces bounding the outer layers of the shock absorbing assemblies.

Preferably, the housing is fixed, integrally formed or otherwise rigidly attached to the tool support coupling and/or linkage coupling.

Preferably, the interior surface of the housing is shaped to correspond at least partially to the shape of the outer layers of the shock absorbing assemblies or vice versa such that outer surfaces of the shock absorbing assembly outer layers abut adjacent the interior surface of the coupling.

The housing is preferably constructed from an inelastic material.

Preferably, the outer layers of the shock absorbing assemblies are elastic.

A relatively smooth interior surface of the housing is required to prevent damage to the outer elastic layers. However, machining the interior surface of coupling precisely is difficult in the field and requires significant downtime in operations. Thus, in one embodiment a lining is included between the shock absorber outer layers and the housing interior surface. Preferably, the lining has low friction surfaces relative to the outer elastic layer.

Thus, the lining may be replaced if worn or when an entire shock absorber needs replacing. A shock absorber or assembly can be replaced in the field with minimal downtime in operation.

It can thus be seen that the present invention may be considered to reside in a tool connection, shock absorber, shock absorption system, hammer and a control linkage for attaching tools such as hammers to a carrier.

Therefore, it can be seen that the present invention offers significant advantages over the prior art including;
a. reducing the shock transmitted to the tool support (e.g. carrier arm) from the tool;
b. absorbing part of the shock of relative movement between the tool and tool support;
c. providing a compact shock absorber;
d. being sufficiently robust to withstand very high shock loads;
e. easy to produce and replace after wear;
f. easily replaced without requiring offsite disassembly and maintenance;

Reference herein is made to various aspects and embodiments of the present invention. For clarity and to aid prolixity every possible combination, iteration or permutation of features, aspects and embodiments are not described explicitly. Thus, it should be appreciated that the disclosure herein includes any combination, iteration or permutation unless explicitly and specifically excluded.

### BRIEF DESCRIPTION OF DRAWINGS

Further aspects and advantages of the present invention will become apparent from the following description which is given by way of example only and with reference to the accompanying drawings in which:

FIG. 1 shows a side elevation of a hammer attached to an carrier via an articulated control linkage;

FIG. 2 shows a side elevation of a preferred embodiment of the present invention of an articulated control linkage connecting a hammer to a carrier arm;

FIG. 3a) shows a plan view of the first link of the articulated control linkage;

FIG. 3b) shows a side view of the first link of the articulated control linkage;

FIG. 4a shows a partial horizontal cross-section of a secondary tool connection including a shock absorber in the first link of the articulated control linkage;

FIG. 4b) shows a partial vertical cross-section of the tool connection of FIG. 4a;

FIG. 5) shows a vertical cross-section of an alternative embodiment of a tool connection;

FIG. 6a) shows a partial plan view of the primary tool connection of the hammer to the carrier;

FIG. 6b) shows a side view of the primary tool connection of the hammer to the carrier;

FIG. 7a shows a partial horizontal cross-section of a shock absorber at the primary tool connection;

FIG. 7b) shows a partial vertical cross-section of the tool connection of FIG. 6b;

FIG. 8) shows a perspective view of a hammer incorporating the shock absorbers of FIGS. 4 and 7, the hammer making a strike on an inclined rock surface;

FIG. 9 shows a side view of the hammer of the previous figures in a levering and raking operation;

FIG. 10a shows a side view of the hammer of the previous figures making a strike on an inclined rock surface; and

FIG. 10b shows a side view of the hammer of the previous figures making a strike on a rock surface inclined in the opposite direction to that shown in FIG. 10a.

FIG. 11a shows a side view of an inelastic layer of a shock absorbing assembly;

FIG. 11b shows the inelastic layer of FIG. 11a in a bent state ready for assembly;

FIG. 11c shows another inelastic layer of a shock absorbing assembly.

FIG. 12 shows the inelastic layer of FIG. 11b.

### BEST MODES FOR CARRYING OUT THE INVENTION

| | |
|---|---|
| 1 | Hammer |
| 2 | Carrier |
| 3 | Articulated control linkage |
| 4 | first link |
| 5 | second link |
| 6 | striker pin |
| 7 | striker pin head |
| 8 | lift drive |
| 9 | primary tool connection |
| 10 | primary connection axis |
| 11 | secondary connection axis |
| 12 | tertiary connection axis |
| 13 | quaternary connection axis |
| 14 | impact axis |
| 15 | hydraulic ram |
| 16 | carrier arm |
| 17 | first link shaft |
| 18 | work surface |
| 19 | linkage shock absorbers |
| 20 | mounting shock absorbers |
| 21 | primary pivot point shaft |
| 22 | first shock absorbing assembly |
| 23 | second shock absorbing assembly |
| 24 | elastic layers |
| 25 | inelastic layers |
| 26 | housing interior surface at secondary tool connection |
| 27 | housing interior surface at primary tool connection |
| 28 | first locator bearing |
| 29 | second locator bearing |
| 30 | first coupling |
| 31 | second coupling |
| 32 | secondary load direction at secondary axis |
| 33 | end caps |
| 34 | end cap bolts |
| 35 | hammer lugs |
| 36 | truncated oval shock absorber |
| 37 | third locator bearing |
| 38 | third coupling housing interior surface |
| 39 | principal load direction at primary pivot axis |
| 40 | hammer mounting |
| 41 | deformation space |
| 42 | principal load direction at secondary axis |
| 43 | Inelastic layer location projections |
| 44 | Inelastic layer bend |
| 45 | Inelastic layer periphery |
| 46 | secondary load direction at primary connection axis |
| 47 | secondary tool connection |
| 48 | tertiary tool connection |
| 49 | quaternary tool connection |
| 50 | housing at secondary tool connection |
| 51 | housing at primary tool connection |
| 52 | elastic layer location apertures |
| 53 | elastic layer periphery |

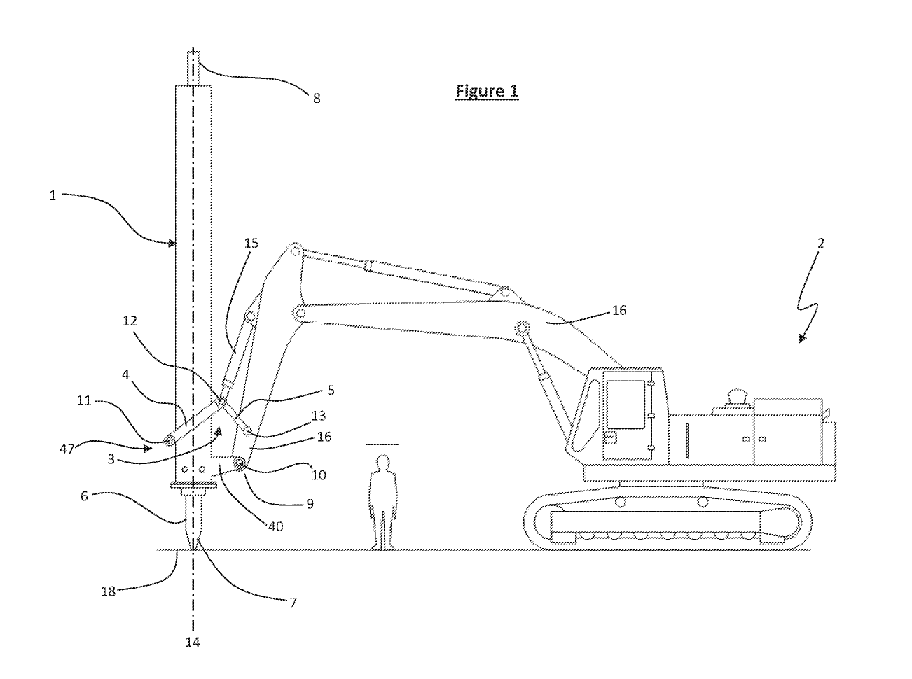

FIGS. 1-4 and 5-10 show a first embodiment of the present invention in the form of a tool connection (9, 47) for connecting a tool in the form of impact hammer (1) with tool support in the form of an operating arm (16) of a carrier (2).

The impact hammer (1) is attached to the carrier arm (16) via mounting (40) and an articulated control linkage (3). The articulated control linkage includes first (4) and second (5) links. The articulated control linkage (3) enables the hammer (1) to be used for levering and raking. It will be understood both the hammer (1) and carrier (2) shown are used for exemplary purposes only and the invention is not limited to same.

The present invention is primarily adapted for use with impact hammers (1) such as gravity drop hammers, powered drop hammers, hydraulic hammers, pneumatic hammers, vacuum-assisted hammers and the like. Although specific implementations of such designs differ, each generally includes some form of movable mass located within the hammer housing and capable of linear reciprocating movement along an impact axis (14).

The hammer (1) includes an elongate striker pin (6) having two opposed ends and a longitudinal axis coaxial with the impact axis (14). A movable mass (not shown) within the hammer (1) is lifted by drive (8) and then dropped onto the striker pin (6). One end of the striker pin (6) projects from the hammer (1) to form an operative tool head (7) which contacts rock to be broken while the other end receives the movable mass impact. The striker pin (6) is also used during levering and/or raking operations.

The striker pin (6) is located at the lower end of the hammer (1). Such a configuration is described in greater detail in U.S. Pat. No. 7,980,240 by Robson—incorporated herein by reference.

In alternative embodiments, the movable mass and striker pin may be formed as a single element which is locked from movement during levering and raking with one end of the pin projecting from the hammer to form the tool head. It will be appreciated however that in such embodiments (not shown), a hammer tool lock (as described in U.S. Pat. No. 7,407,017 by Robson—incorporated herein by reference) is beneficial in order to fix the mass and pin relative to the hammer housing during raking and levering operations.

Thus, depending on the construction of the hammer (1), the tool may be formed as a moveable weight and locked from movement during levering and raking; or, the formed as a separate element (i.e. the striker pin (6)) distinct from the movable mass.

The hammer (1) is attached at a primary tool connection (9) at a distal end of the operating arm (16) of the carrier (2) enabling relative pivotal movement about a primary connection axis (10) orthogonal to the impact axis (14).

The articulated control linkage (3) provides a means for effecting pivotal movement of the hammer (1) about the primary axis (10) in response to movement from a drive in the form of a hydraulic ram (15) attached to the operating arm (16).

The first link (4) is pivotally attached to the hammer (1) at a first end to form a secondary tool connection (47) enabling relative rotation of the hammer (1) and first link (4) about a secondary connection axis (11) parallel to the primary axis (10). The first link (4) is also pivotally attached at a second end to the second link (5) at a tertiary tool connection (48) enabling relative rotation of the first (4) and second (5) links about a tertiary connection axis (12).

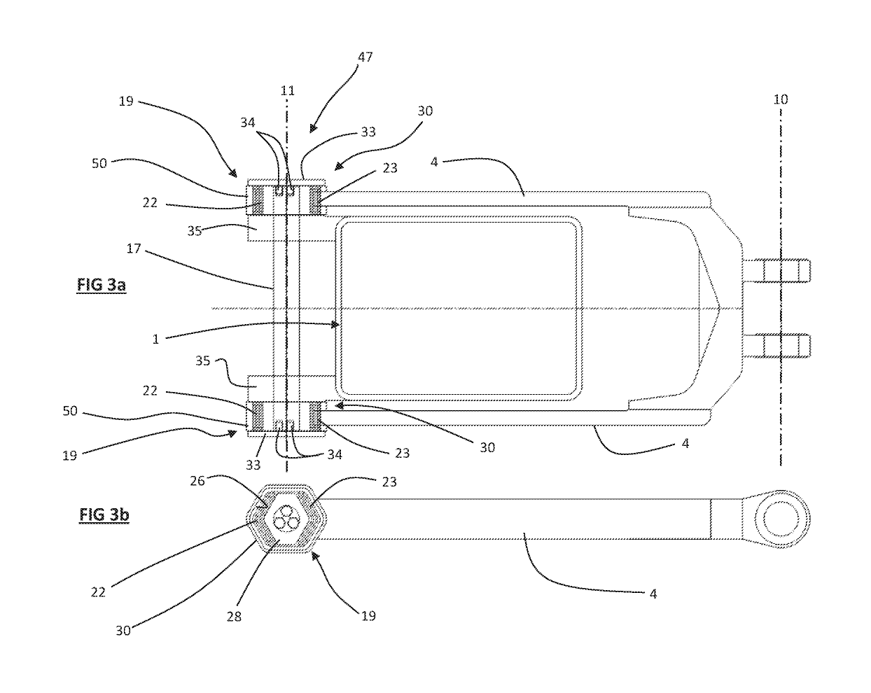

The second link (5) is pivotally attached at a first end to form a quaternary tool connection (49) enabling relative rotation about a quaternary pivot point axis (13) with respect to the carrier arm (16), the quaternary connection axis (13) being parallel to the secondary (11) and tertiary (12) axes, the second link (5) also being pivotally attached at a second end to the second end of the first link (4) at the tertiary connection axis (12) and to the drive (15), coaxial with the tertiary pivot point axis (12). The first link (4) is comprised of a pair of arms (4) passing either side of the hammer (1) as shown in FIG. 3a). Encircling the hammer (1) in this manner provides a robust configuration capable of withstanding the high loads imposed during levering and raking operations whilst also reducing the tipping moment of the carrier (2). A shaft (17) extending along the secondary connection axis (11) between the arms (4) provides further structural integrity to the control linkages. It will be appreciated that in an alternative embodiment (not shown), a pair of the drives (15), on opposed lateral sides of the arm (16), may be used to act on the individual arms (4) on opposing sides of the hammer (1).

Thus the primary tool connection axis (10) is located laterally to the impact axis (14) between the opposed distal ends of the striker pin (6) and the primary, tertiary and quaternary pivot axes (10, 12, and 13) are all located on an opposing side of the impact axis (14) to the secondary connection axis (11). The primary tool connection (9) is located in a region between the striker pin head (7) and a line subtended orthogonally from the impact axis (14) from the end of the striker pin (6) distal to the tool head (7).

This enables significantly higher levering forces/torque to be applied by the striker pin (6) by increasing the separation between the primary connection axis (10) and the secondary connection axis (11) whilst minimizing the distance from the striker pin tip (7) to the primary connection axis (10). Moreover, the geometry of the control linkage (3) enables a higher degree of levering power to be applied evenly throughout the full stroke of the drive (7) pivoting the hammer (1) about the primary axis (10).

In operation; extension or retraction of the hydraulic ram (7) acts to pivot the first and second links (4, 5) in opposing directions about the secondary connection axis (11) and quaternary connection axis (13) respectively. Both links also pivot in opposite directions about the tertiary connection axis (12). As the ram (15) extends, the first and second links (4, 5) are splayed apart at the tertiary connection axis (12) and thus the angle subtended therebetween is increased whilst the secondary connection axis (11) is pushed out away from the carrier arm (16). The force from the drive (15) acting along the first link (4) applies a torque to the hammer (1) at the secondary connection axis (11), causing the hammer (1) to pivot about the primary connection axis (10) with the tip of the striker pin (6) moving towards the carrier.

Thus, the hammer (1) may not only be operated to break rock, concrete or other material by percussion impacts of the striker pin (6) along the impact axis (14), but also to rake or lever material by a pivoting and locking action about the primary connection axis (10).

When working in breaking applications the hammer (1) is used to deliver impacts to a rock, steel or other work surface to be broken. Minimising the distance between the striker tip (7) to the primary connection axis (10) also optimises the raking ability of the hammer (1) and carrier arm (16) assembly in addition to minimising the shock loading on the carrier (2) during percussion impacts on the striker pin (6).

In ideal conditions, the striker pin (6) impacts a surface aligned perpendicular to the impact axis (14) so that all the force is transmitted to the surface (18) and any shock travels along the impact axis (14), constraining the majority of any shock within the hammer (1). However, if the surface (18) is not perpendicular to the impact axis (14), a portion of the impact force is diverted laterally and/or rotationally with respect to the impact axis (14). The carrier arm (16) is held stationary by the carrier (2) and thus the diverted impact forces try to move the hammer (1) with respect to the carrier arm (16), thereby causing significant shock and/or torsion to the hammer (1) and connections (3, 40).

Moreover, in levering and raking applications there are very high loadings on the tool connections (9, 47, 48, 49) and linkages (4, 5) of the articulated control linkage (3).

The forces involved in operating the hammer (1) are such that inclined impacts as described above or levering/raking operations can result in reactionary forces that damage the hammer (1), linkage (3), mounting (40) and/or associated tool connections to the carrier arm (16). The potentially damaging forces are typically high-magnitude, short time period forces, i.e. shocks. The shock can be sufficient to crack the steel welds in the mounting (40), linkage (3) or carrier arm (16). Shock absorbers (19, 20) are thus provided to shock isolate the carrier arm (16) from the hammer (1) and mitigate the potential for damage. There are inherent space constraints in these tool connections and thus prior art shock absorbers, (necessarily very large) would not be suitable.

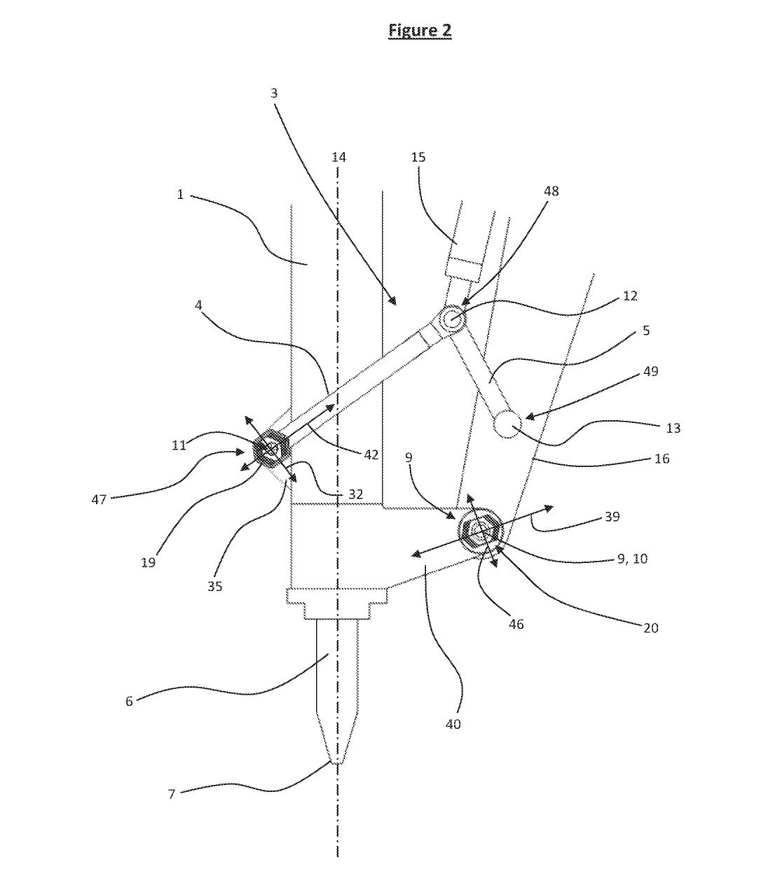

FIG. 2 shows shock absorbers (19, 20) incorporated into two of the tool connections (9, 47). The tool connections (9, 47) each include a shaft (21, 17) with a longitudinal axis (10, 11) forming the corresponding connection axis (10, 11).

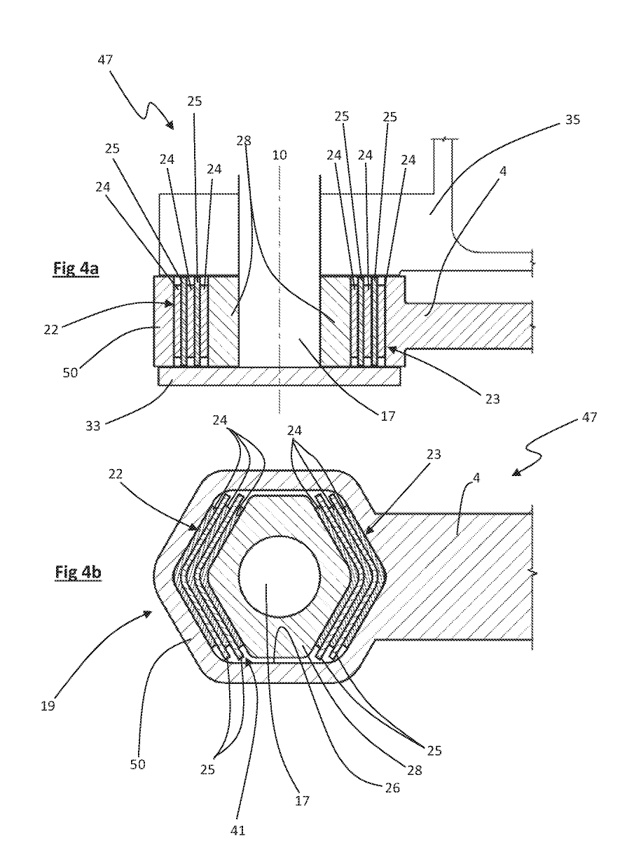

FIGS. 3-4 show more clearly the shock absorber (19) of the secondary tool connection (47) at the coupling (30) of the hammer (1) to the arms of the first link (4).

The shock absorber (19) includes two shock absorbing assemblies (22, 23), with each assembly including radially distributed layers (24, 25). The embodiment shown includes three elastic layers (24) with two inelastic layers (25) interleaved therebetween. Each shock absorbing assembly (22, 23) is radially distributed two corresponding inelastic layers provided in the form of steel locator bearings (28) and housing interior surfaces (26), also constructed from steel. The steel locator bearings (28) thus provide an inner inelastic layer of the shock absorber while the housing interior surfaces (26) provide the outer inelastic layer of the shock absorber (19). The housing inner surfaces (26) form part of a housing (50) at the end of the corresponding couplings (30). The housing (50) encases and encloses the shock absorber assemblies (22, 23).

The locator bearings (28) also form corresponding locators for maintaining alignment of the shock absorbing assemblies (22, 23).

The layers (24, 25, 26, 28) of the shock absorber (19) are un-bonded and radially stacked with respect to the corresponding connection axis (11), with an inner layer (28) located at a smaller radial distance to the corresponding connection axis (11) than an outer layer (26).

The shock absorbers (19) are each formed from an un-bonded stack of interleaved elastic (24) and inelastic (25) layers such that the elastic layers (24) will deform and spread along the abutting surfaces of the adjacent inelastic layers (25, 26, 28) under load. The energy of the load is absorbed, not only in deformation of the elastic layers (24) but also in the friction resulting from the relative movement between the elastic (24) and inelastic layers (25, 26, 28). Such a multi-layered un-bonded shock absorber (19) is capable of absorbing far greater loads than a unitary shock absorber of same volume, or bonded multi-layer shock absorber.

The shock absorbing assemblies (22, 23) each only extend about a portion of the connection axis (11) to ensure that there are deformation voids (41) to accommodate deformation of the elastic layers (24). Thus, the elastic layers (24) are constrained only by the adjacent inelastic layers (25, 26, 28) in directions perpendicular to the plane of the elastic layers (24).

The shock absorbing assemblies (22, 23) are positioned diametrically opposite each other about the connection axis (11) and aligned to absorb the load in the ‘principal’ or ‘primary’ direction. In typical applications, this principal load direction (42) is aligned along the first link arms (4), particularly during levering or raking using the hammer (1). Alignment of the shock absorbing assemblies (22, 23) is thus important to retain maximum effectiveness. The steel locator bearings (28) and coupling interior surfaces (26) are therefore shaped so as to limit movement of the shock absorbing assemblies (22, 23) about the connection axis (11) relative to the housing interior surface (26).

The embodiment of the shock absorbers (19) shown in FIGS. 1-4 has a locator bearing (28) with an irregular hexagonal shape in a cross-section perpendicular to the connection axis (11). Similarly, the housing interior surface (26) of the coupling (30) also has a hexagon shaped cross-section, though regular. The layers (24, 25) of each shock absorbing assembly (22, 23) are correspondingly shaped to match those of the locator bearing (2) and housing interior surface (26).

Thus, the shock absorbing assemblies (22, 23) are constrained in their location (relative to the first link (4) by the locator (28), and coupling interior surface (26). The shaped locator bearing (28) and housing inner surface (26) provide constrictions at each change in angle, thereby opposing any rotation of the shock absorbing assemblies (22, 23). The shock absorber (19) is thus shaped to prevent rotation and thereby maintain the orientation relative to the principal load direction (42) at the secondary connection axis (11).

In contrast, using a circular cross-section arrangement with concentric layers would likely result in the assemblies (22, 23) moving about the connection axis (11) and becoming misaligned, thus requiring some other form of locating mechanism.

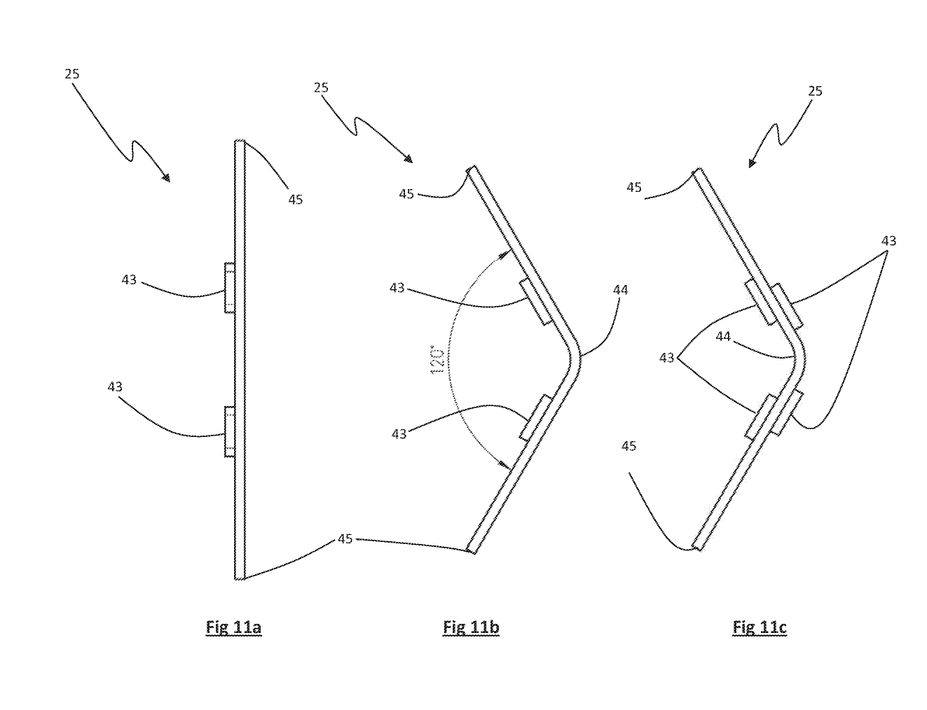

It is also important to limit the relative movement of layers (24, 25) about the connection axis (11) so they do not become misaligned. Thus, the inelastic layers (25) include location features provided in the form of steel projections (43) (shown in FIG. 11a, 11b, 11c) welded to the inelastic layers (25). When the shock absorbing assemblies (22, 23) are assembled, the projections (43) are inserted inside corresponding location features (provided as apertures (52)) in the adjacent elastic layers (24). The projections (43) thus limit the relative movement of the layers (24, 25) and maintain alignment.

Similar location features may also be provided on the housing interior surfaces (26, 27) and/or the shaft (17, 21).

It is important that the elastic layers (24) interleaved between inelastic layers (25) are capable of deforming under compression and thus the projections only project from the inelastic layer (25) to extend partially through the thickness of the elastic layers (24) when assembled.

The location projections (43) may however cause damage to the elastic layers (24) if there is sufficient relative movement with adjacent inelastic layers (25) such that, for example, a projection (43) pushes against the side of a corresponding aperture.

The portions of the elastic layers (24) toward their periphery generally move a greater distance under compression than portions closer to the center and therefore have the potential to provide the greatest degree of relative movement between layers (24, 25). Thus, it is preferable to locate the location projections (43) on portions of the layers (25) that experience the least or only small degrees of relative movement with adjacent layers.

Thus, the projections (43) are located closer to the bend line (44) of the inelastic layers (25) than to the periphery (45). It should be appreciated that the coupling (30) may be provided as a separate component to the link (4), e.g. a separate joint, bearing or other mechanism.

The potential loading applied in other directions to the principal load direction (42) noted above is generally much less than the principal load but may still be significant. The shape of the locator bearing (28) and housing interior surface (26) ensures that if the locator bearing (28) experiences a load with a component in a direction perpendicular (hereinafter secondary load direction (32)) to the principal load direction (42) it will still compress the shock absorbing assemblies (22, 23) and cause relative movement of the layers (24, 25) therein. The shock absorber (19) is thus also capable of mitigating shock with a component in the secondary load direction (32).

Moreover, torsional loads about the link (4) are also mitigated by the shock absorber (19). It can thus be seen that although the shock absorber (19) does not fully encircle the connection axis (11) it is still capable of mitigating shock in any direction to varying levels.

The shaft (17) of the first link (4) passes through an aperture in the locator bearing (28) and is free to rotate within the locator bearing (28) about the secondary connection axis (11). The shock absorbing assemblies (22, 23) are axially constrained about the shaft (17) by the connecting lugs (35) of the hammer (1) and end caps (33) which are bolted to shaft (17) via bolts (34). Thus, the shock absorbing assemblies (22, 23) cannot fall out of the couplings (30, 31).

The housing interior surface (26) is formed from cast steel which typically has a rough surface unless machined smooth. This rough surface can damage the adjacent elastic layer (24). It may thus be necessary to machine the coupling interior surface (26) when replacing worn shock absorbers (19). This requirement can result in significant downtime in operation, particularly, if the machining must be completed offsite. Thus, thin, low-friction linings (not shown but being of the same shape as the interior surface (26)) of steel or any smooth material, may also be provided between the shock absorber outer elastic layer (24) and the coupling interior surfaces (26). The lining can be replaced when a shock absorbing assembly (19) is replaced, thus avoiding the need to smooth the coupling interior surfaces (26).

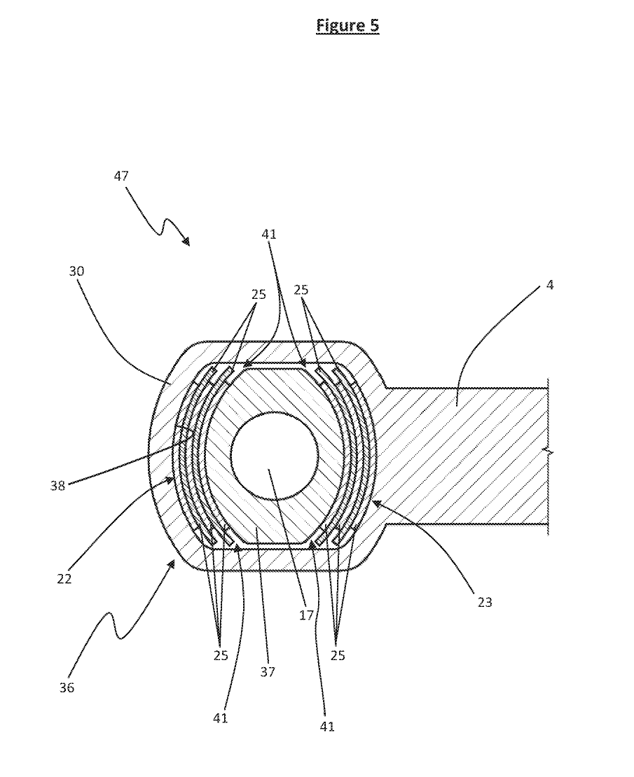

FIG. 5 shows the tool connection (47) with a shock absorber (36) according to another embodiment of the present invention and operates in a generally similar manner to the shock absorbers (19) of FIGS. 3-4. However, the shock absorber (36) differs in that its locator bearing (37) and coupling interior surface (38) have a cross-sectional shape of a truncated oval rather than the hexagonal version of the aforementioned shock absorber (19). The shock absorbing assembly layers (24, 25) are thus correspondingly shaped as arcuate layers to match the curvature of the locator bearing (37) and coupling interior surface (38).

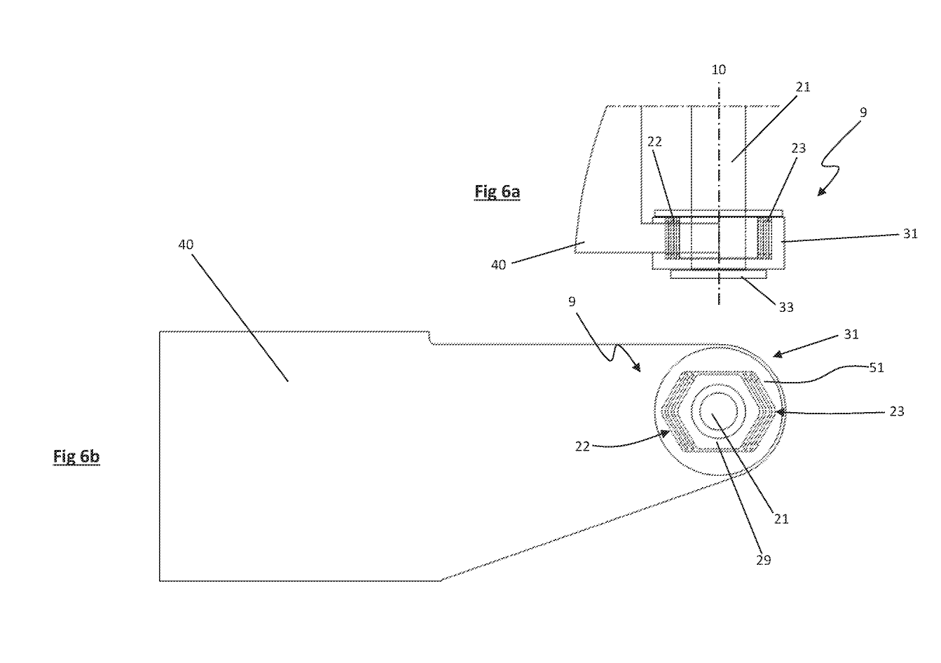

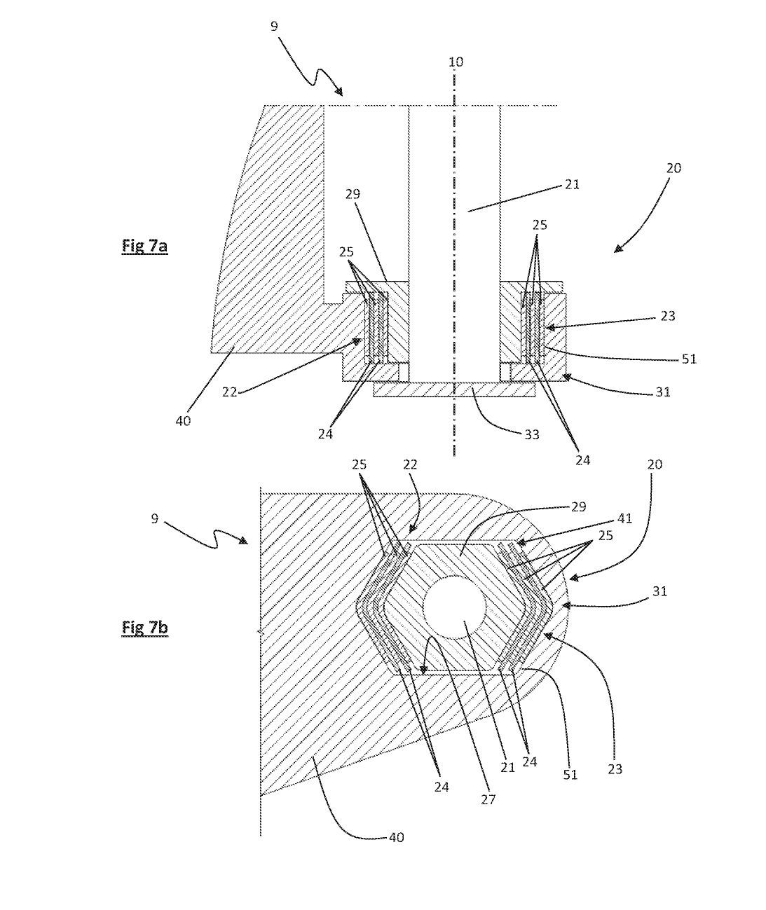

FIGS. 6 and 7 shows the primary tool connection (9) of the hammer (1) to the carrier arm (16). The shock absorbers (20) (only one shown) in the primary tool connection (9) are located in housings (51) at the couplings (31) on either side of the carrier arm (16), the coupling (31) pivotally attached to a shaft (21) passing through carrier arm (16).

The shock absorbers (20) at the primary tool connection (9) as shown in FIGS. 6 and 7 are generally similar and operate equivalently to that of the shock absorbers (19) at the secondary tool connection (47) of FIGS. 3-5 but differ in that the locator bearing (29) has a regular hexagonal cross-section and the housing interior surface (27) has an irregular hexagonal cross-section. The principal load direction (39) at this primary tool connection (9) is generally aligned along the hammer mounting (40).

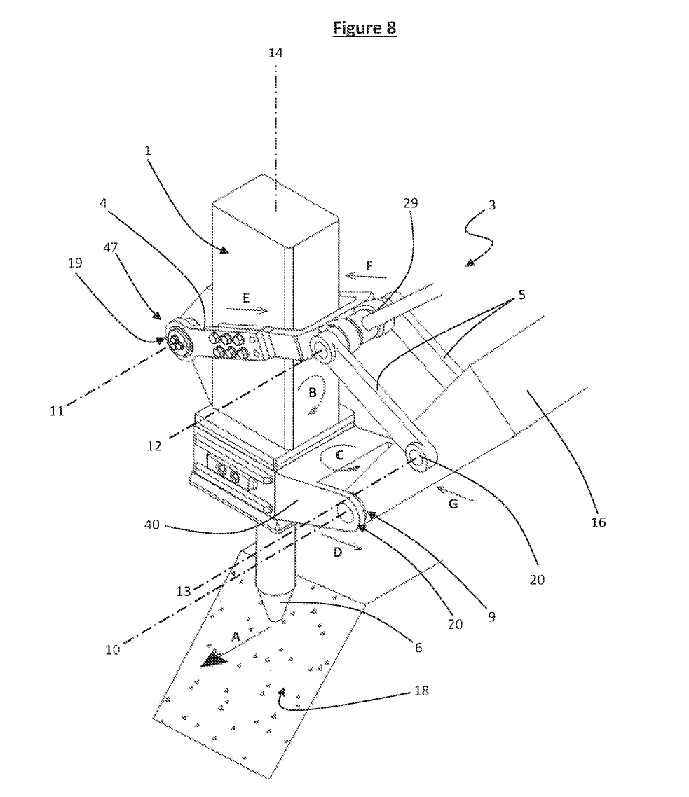

An example of a strike on an inclined work surface (18) is shown in FIG. 8 and shows the hammer (1) making a strike on an inclined work surface (18) orientated at 45 degrees to the impact axis (14). The striker pin (6) and hammer (1) are deflected sideways with a force vector (A) resulting in a linear component generally in the direction (A) along with a torque component (B) about an axis perpendicular to the impact axis (14). The torque component (B) results in loads on the tool connections (9, 47) in both the secondary load directions (32, 46) and principal load directions (42, 39).

The hammer (1) is constrained by the tool connection (9) to the carrier arm (16) and so the linear component (A) results in a torque component (C) about an axis generally located at the connection to the carrier arm (16) and approximately parallel to the impact axis (14). This torque component (C) has components (E) and (F) along the principal load direction (42) at linkage shock absorbers (19) and with components (D) and (G) along principal load direction (39) at shock absorbers (20).

In the example of FIG. 8 the linkage shock absorbers (19) at the secondary connection axis (11) work to mitigate the shock components (B), (E) and (F) while the hammer mounting shock absorbers (20) at the primary connection axis (10) reduce the shock components (B), (D) and (G). It will be appreciated that this is a simplistic example only as the work surface (18) in actual operation will be rarely inclined at such a constant angle. The actual force components will thus vary depending on the inclination and direction of the work surface (18), the impact force and orientation of the hammer (1). However, the shock absorbers (19, 20) as described ensure that they will absorb shock no matter what direction the impact force components take and thus reduce the shock transmitted to the carrier arm (16) and thus carrier (2).

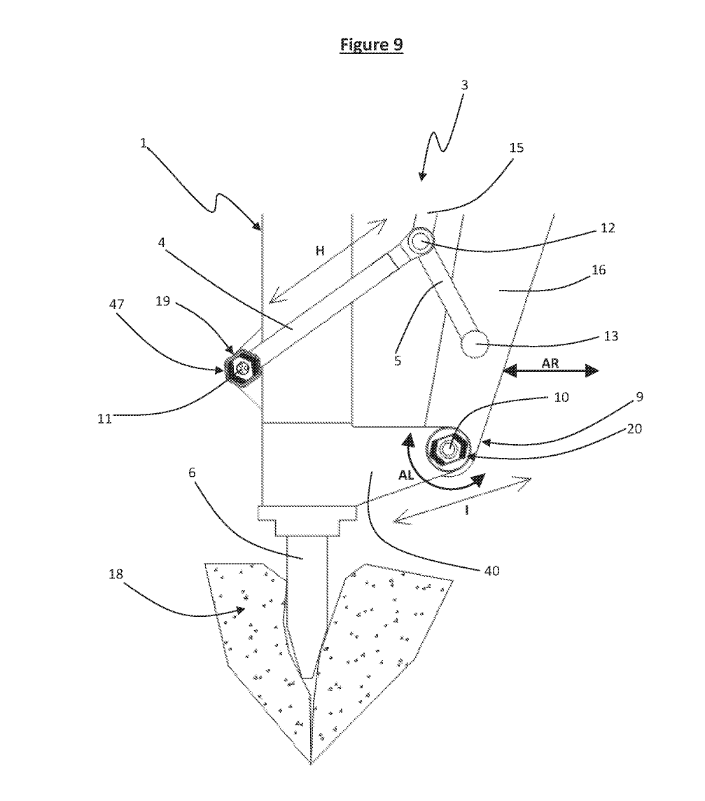

FIG. 9 shows an example of the loads on the articulated control linkage (3) when the hammer (1) is used in raking or levering operations.

FIG. 9 shows the hammer (1) after an impact where the striker pin (6) has cracked a rock (18) with the striker pin (6) in the crack. The rock (18) can be levered apart by extending or retracting hydraulic ram (15) to respectively spread or close linkages (4, 5) to pivot the hammer (1) and striker pin (6) about the primary connection axis (10) (as indicated by arrow (AL) thus levering the rock (18) apart. The torque (AL) and opposing resistance from the rock (18) results in linear components:
(H) along the first link (4), and
(I) along the hammer mounting (40).

In raking operations, the carrier arm (16) or carrier (2) is manoeuvred to pull or push the striker pin (6) generally in the directions indicated by double arrow (AR). Raking thus also results in load components along (H) and (I).

In both levering and raking applications the linkage shock absorbers (19) at the secondary connection axis (19) at least partially absorb any shock or vibration component (H) while the hammer mounting shock absorbers (20) at the primary connection axis (10) least partially absorbs any shock component (I).

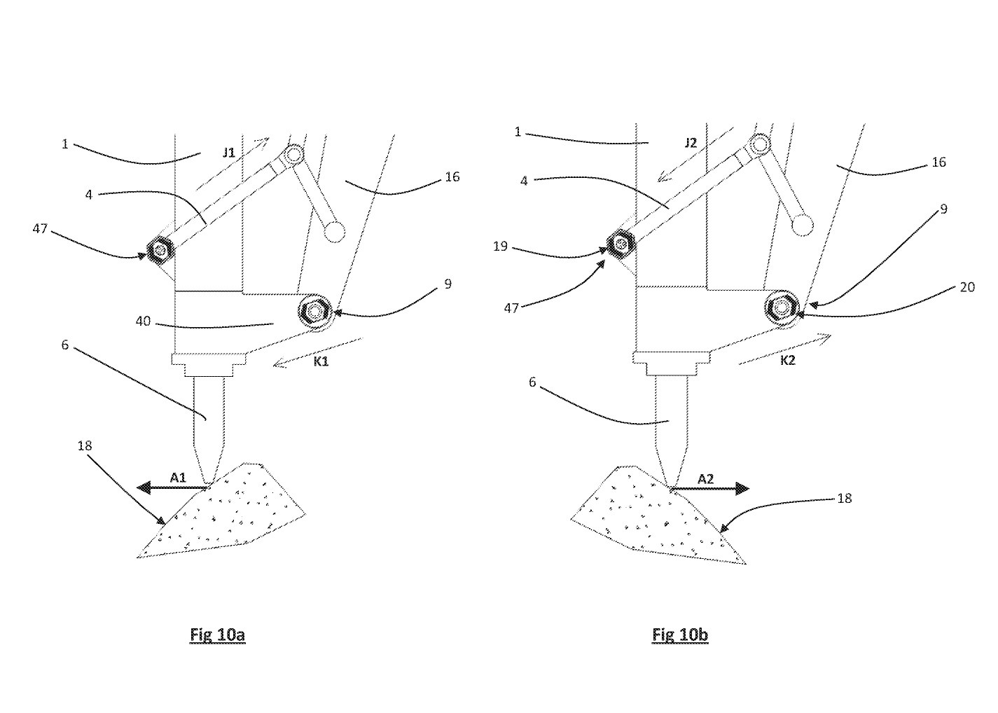

FIG. 10 shows two examples of the hammer (1) making strikes on rocks with inclined surfaces (18). FIG. 10a shows a rock with surface (18) inclined with respect to the impact axis (14) downwardly in a direction directly away from the carrier (2). FIG. 10b shows the converse arrangement with surface (18) inclined with respect to the impact axis (14) downwardly in a direction directly toward the carrier (2).

In the example of FIG. 10a the striker pin (6) is deflected with vector (A1) and the hammer experiences shock in directions (J1) and (K1). The linkage shock absorbers (19) at the thus absorb part of the (J1) component while the hammer mounting shock absorbers (20) absorb part of the (K1) component. The example of FIG. 10b has a principal load vector (A2) in the opposite direction to that shown in FIG. 10a and thus components (J2) and (K2) are opposite to that shown in FIG. 10a.

The shock absorbers (19, 20) as described ensure that they will absorb shock no matter what direction the impact force components (J, K) take and thus reduce the shock transmitted to the carrier (2).

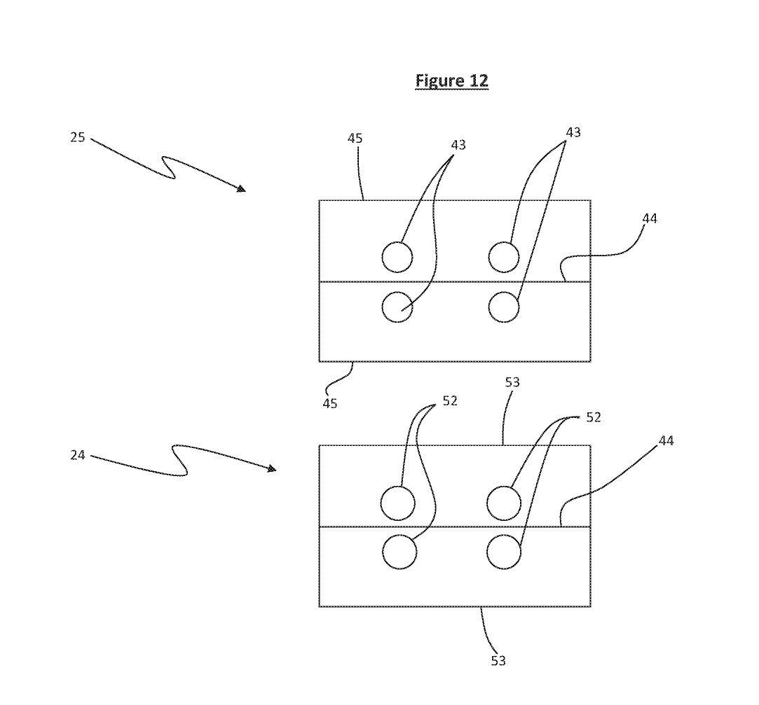

FIGS. 11 and 12 show elastic and inelastic layers with mating location features (43, 52) therein.

FIG. 11a shows an enlarged view of an inelastic layer (25) before being bent ready for assembly. Location projections (43) are welded to one side of the steel inelastic layer (25) and will mate with corresponding recesses or apertures (52) in an adjacent elastic layer (24) that when assembled will be to the left (with respect to drawing) of the inelastic layer (25). FIG. 11b shows the same inelastic layer (25) when bent about bend (44) that extends parallel with the corresponding connection axis (10, 11) when assembled.

FIG. 12 shows the inelastic layer (25) and elastic layer (24), the inelastic layer (25) having the location projections (43) thereon and the elastic layer (24) having corresponding recesses (52). The recesses and (52) and projections (43) are proximal to the bend lines (44) relative to the corresponding periphery (53, 45).

The radially inner-most inelastic layer (25) of each shock absorbing assembly (22, 23) holds the inner-most elastic layer (24) in relative alignment.

The outer-most inelastic layer (25) is shown enlarged in FIG. 11c and has location projections (43) on both sides, mating with recesses in elastic layers (24) on either side.

The movement of each elastic layer (24) is thus limited by the projections (43) of an adjacent inelastic layer (25), ensuring the elastic layers maintain alignment.

Each assembly (22, 23) is thus formed from sets of connected layers (connected by projections (43)) with an:
inner-most pair of an inelastic layer (25) and an elastic layer (24), and
outer-most triple comprised of an inelastic layer (25) interleaved between two elastic layers (24).

It should be appreciated that alternatively the inner-most inelastic layer (25) could have projections (43) on both sides mating with recesses in elastic layers (24) on either side, thus forming the triple set.

This configuration, ensures that each set of layers, as pairs or a triple, is still free to move relative to an adjacent set(s) thus ensuring that the shock absorbers (19, 20) can accommodate loads with a component along the secondary load directions (32, 46).

The drawings of the shock absorbing assemblies (22, 23) are simplified for clarity and show only five layers in total, three elastic (24) and two inelastic (25) layers. However, more layers are typically included, with the number of elastic layers (24) equal to the number of inelastic layers (25) plus one.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

1. A tool connection for connecting a tool to a tool support, the tool connection including at least one radial shock absorber for at least partially absorbing shock imparted by the tool via the tool connection, the radial shock absorber having at least one shock absorbing assembly including:
at least two elastic layers;
at least one inelastic layer interleaved between said elastic layers,
wherein the layers of the shock absorbing assembly are radially distributed with respect to a connection axis passing through the tool connection, the shock absorbing assembly elastic layers including an inner elastic layer and an outer elastic layer radially proximal and distal respectively to the connection axis;
wherein the inelastic and elastic layers are un-bonded, permitting relative movement therebetween.

2. (canceled)

3. (canceled)

4. The tool connection as claimed in claim 1, wherein the at least one shock absorbing assembly is radially distributed between an inner inelastic layer and an outer inelastic layer, the outer inelastic layer including the inner walls of a housing at least partially encircling the connection axis.

5. (canceled)

6. (canceled)

7. The tool connection as claimed in claim 4, wherein movement of the at least one shock absorbing assembly about the connection axis is restricted by the interior surface of the housing.

8. (canceled)

9. (canceled)

10. (canceled)

11. The tool connection as claimed in claim 1, wherein the at least one shock absorbing assembly includes at least three elastic layers and at least two inelastic layers, the inelastic layers interleaved between adjacent pairs of elastic layers.

12. The tool connection as claimed in claim 1, wherein the at least one shock absorbing assembly only partially encircles the connection axis.

13. The tool connection as claimed in claim 1, wherein the shock absorber includes at least one deformation void for the elastic layers to deflect or deform into.

14. The tool connection as claimed in claim 13, wherein the deformation void is provided between inelastic layers adjacent a periphery of a said elastic layer between the inelastic layers.

15. The tool connection as claimed in claim 1, wherein the shock absorber includes at least two of said shock absorbing assemblies, each shock absorbing assembly including:
at least two elastic layers;
at least one inelastic layer interleaved between the two elastic layers.

16. (canceled)

17. (canceled)

18. The tool connection as claimed in claim 15, wherein the at least two shock absorbing assemblies collectively only partially encircle the connection axis.

19. The tool connection as claimed in claim 18, wherein a deformation void is formed in a gap about the connection axis between the at least two shock absorbing assemblies.

20. The tool connection as claimed in claim 1, wherein the elastic layers are substantially coterminous perpendicular to a direction of principal load.

21. The tool connection as claimed in claim 1, wherein alignment of the at least one shock absorbing assembly is maintained by at least one locator, positioned between the connection axis and the at least one shock absorbing assembly.

22. (canceled)

23. The tool connection as claimed in claim 21, wherein the locator includes a shaped locator bearing located about the connection axis, the locator bearing including an aperture for a shaft to pass therethrough which is capable of rotating about the connection axis relative to the locator bearing.

24. The tool connection as claimed in claim 21, wherein the locator is non-circular in cross-section perpendicular to the connection axis.

25. The tool connection as claimed in claim 24, wherein in cross-section perpendicular to the connection axis, the locator is shaped as one of a: polygon;
truncated ellipse; regular hexagon; irregular hexagon with a long axis and a short axis intersecting at the connection axis.

26. (canceled)

27. (canceled)

28. (canceled)

29. The tool connection as claimed in claim 1, wherein relative alignment of the shock absorbing assembly layers is maintained by nesting the shock absorbing assembly layers.

30. (canceled)

31. The tool connection as claimed in claim 1, wherein location features are provided in or on the shock absorbing assembly layers to limit relative movement of adjacent layers wherein the location features are provided as mating, interlocking or meshing features on adjacent layers.

32. (canceled)

33. (canceled)

34. (canceled)

35. (canceled)

36. (canceled)

37. The tool connection as claimed in claim 1, wherein the tool is an impact hammer formed with a moveable mass in a hammer housing and a striker pin, and the tool support is an operating arm of a carrier.

38. (canceled)

39. (canceled)

40. (canceled)

41. (canceled)

42. (canceled)

43. The tool connection as claimed in claim 1, wherein a said shock absorbing assembly includes multiple inelastic layers interleaved between corresponding pairs of elastic layers.

44. A radial shock absorber for use in a tool connection, the radial shock absorber having at least one shock absorbing assembly radially distributed between two inelastic layers, the shock absorbing assembly including:
at least two elastic layers;
at least one inelastic layer interleaved between said elastic layers,
wherein the layers of the shock absorbing assembly are radially distributed with respect to a connection axis passing through the tool connection, the shock absorbing assembly elastic layers including an inner elastic layer and an outer elastic layer radially proximal and distal respectively to the connection axis;
wherein the inelastic and elastic layers are un-bonded, permitting relative movement therebetween.

45. (canceled)

46. (canceled)

47. An impact hammer including:
a movable mass capable of linear reciprocating movement for impact along an impact axis,
an elongated striker pin received within the hammer having a longitudinal axis substantially parallel or coaxial with said impact axis, said striker pin having two opposed ends with one end projecting from the hammer to form an operative tool head;
a tool connection, hereinafter “primary tool connection” adapted for attaching the hammer to a distal end of an operating arm attached to the carrier;
wherein the impact hammer includes at least one shock absorber at the primary tool connection, for at least partially absorbing shock imparted by the hammer via the tool connection, the radial shock absorber having at least one shock absorbing assembly including:
at least two elastic layers;
at least one inelastic layer interleaved between said elastic layers,
wherein the layers of the shock absorbing assembly are radially distributed with respect to a connection axis passing through the tool connection, the shock absorbing assembly elastic layers including an inner elastic layer and an outer elastic layer radially proximal and distal respectively to the connection axis.

48. (canceled)

49. (canceled)

50. (canceled)

51. (canceled)

52. (canceled)

53. (canceled)
